(19) United States
(12) Patent Application Publication
(10) Pub. No.: US 2024/0238910 A1
(43) Pub. Date: Jul. 18, 2024

(54) COMPOSITE METAL MATERIAL AND LOW-TEMPERATURE SOLDER PASTE WITH HIGH THERMAL CONDUCTIVITY CONTAINING SAME

(71) Applicants: Xiamen Jissyu Solder Paste Co., Ltd., Xiamen (CN); Xiamen University, Xiamen (CN)

(72) Inventors: Xuzhang ZHENG, Xiamen (CN); Zhihao Zhang, Xiamen (CN); Jixian Xing, Xiamen (CN); Guangxin Wang, Xiamen (CN); Shiqin Li, Xiamen (CN)

(21) Appl. No.: 18/449,932

(22) Filed: Aug. 15, 2023

(30) Foreign Application Priority Data
Jan. 13, 2023 (CN) 202310064390.8

(51) Int. Cl. B23K 35/02; B22F 1/05; B22F 1/065; B22F 1/145; B22F 1/17

(52) U.S. Cl. CPC B23K 35/025; B22F 1/05; B22F 1/065; B22F 1/145; B22F 1/17; B22F 2301/10; B22F 2301/15; B22F 2301/255; B22F 2301/30; B22F 2304/10; B22F 2999/00

(57) ABSTRACT

The present invention relates to a composite metal material and a low-temperature solder paste with high thermal conductivity containing the same. The composite metal material is a Cu core/Ag intermediate layer/Sn shell type metal powder (Cu@Ag@Sn) or a Cu core/Ni intermediate layer/Sn shell type metal powder (Cu@Ni@Sn) with a particle size of 20-60 μm. The low-temperature solder paste with high thermal conductivity is obtained by mixing the composite metal material with an Sn—Bi series alloy powder and a flux paste, can be used for welding of a variety of substrate, and is suitable for welding at a low temperature of lower than 150° C. The composite metal material of the present invention has a simple process, a low cost and high practicability, and poor heat dissipation and other problems of power devices after die bonding caused by low thermal conductivity of current solder pastes on the market are solved.

### CROSS-REFERENCE TO RELATED APPLICATIONS

The instant application claims priority to Chinese patent application Ser. No. 20/231,0064390.8, filed on Jan. 13, 2023, which is incorporated herein by reference.

### TECHNICAL FIELD

The present invention relates to the technical field of electronic welding, and in particular to a composite metal material and a low-temperature solder paste with high thermal conductivity containing the same.

### BACKGROUND

With the development of large-scale integration and miniaturization of electronic products, the interconnection density of chips is increased rapidly. Under such background, solder pastes have become the most important connection material in a surface mounted technology (SMT). However, as high-power devices have high heat output and high operating temperature, a new challenge has been put forward for the thermal conductivity of pins used for die bonding. Therefore, the development of pins with high thermal conductivity has become an important research problem.

According to traditional solder pastes, tin-silver-copper (SAC) series alloys are usually used as welding materials, and the welding temperature is usually not lower than 240° C., leading to device deformation and other problems of electronic devices during welding. Therefore, Sn—Bi series alloys have been widely used as solder pastes of low-temperature solders in the market at present, where an eutectic Sn-58Bi alloy has a melting point of 138° C. Among the Sn—Bi series alloys, the content of Bi has great influence on the melting point. When the content of Bi is lower than 58 wt %, the melting point of the alloys is higher than 138° C.; and otherwise, the melting point of the alloys is equal to or lower than 138° C.

On the one hand, segregation of the hard and brittle Bi occurs during solidification of the existing series of alloys, so that the alloys have low thermal conductivity and tensile strength and also have poor mechanical drop impact resistance. On the other hand, the thermal conductivity can be improved by reducing the content of Bi. However, the melting point of the alloys will be increased, and welding of copper pipes needs to be carried out below 140° C. As shown in FIG. 1, a copper pipe and a heat dissipation device are brazed by using a solder. In order to transfer the heat of the copper pipe to the heat dissipation device rapidly for cooling, the thermal conductivity of the solder needs to be increased. Meanwhile, due to the influence of thermal expansion of the copper pipe, the welding temperature of the solder is required to not higher than 150° C. In order to weld the copper pipe to the heat dissipation device, the solder needs to melt at a temperature lower than 140° C. Otherwise, a liquid in the copper pipe has the risk of explosion.

Therefore, the development of a low-temperature solder with high thermal conductivity is of great significance.

Composite solders are a type of novel solders with enhanced properties, which are prepared by adding micro-nano particles, rare elements, porous metals and other materials into traditional solders. In recent years, composite solder joints have attracted great attention in both the academia and the industry due to important properties in traditional solder joints, especially in shear strength, thermal stability, intermetallic compound growth and phase nucleation. It has been found by Liu Yang, et al. at Yangzhou University through research (Liu Yang, et al. Journal of Materials Science: Materials in Electronics. 2020, 31, 8258-8267.) that the thermal conductivity of an Sn58Bi alloy can be increased to 41.32 W/(m·K) by adding a porous foamy Cu sheet into the Sn58Bi alloy. However, the foamy Cu used in this method has high cost, and a lamellar structure obtained cannot be directly used for preparing a solder paste. It has been found by Hao Zhang, et al. at Harbin University of Science and Technology (Hao Zhang, et al. Journal of Materials Science: Materials in Electronics. 2019, 30:340-347) that the thermal conductivity of an Sn58Bi solder layer can be increased from 18.89 W/(m·K) to 26.60 W/(m·K) by adding 5 wt. % of Cu particles with a diameter of 5 μm into an Sn58Bi solder paste, and good thermal properties on LED packaging are achieved. A solder with a Cu@Sn core-shell structure has been put forward by Hongtao Chen, et al. at Harbin Institute of Technology (Hongtao Chen, Tianqi Hu, et al. IEEE Transactions on Power Electronics. 2017, 32(1): 441-51.). Cu@Sn core-shell metal particles are formed by plating Sn on the surfaces of Cu particles, and then the Cu@Sn core-shell metal particles are pressed at a pressure of 30 MPa to obtain a composite solder sheet with a size of 400±20 μm for Cu-Cu connection. Due to a large number of Cu cores, the thermal conductivity of the composite solder sheet can reach 127.99-154.26 W/(m·K). However, welding of the composite solder sheet needs to be carried out at 250° C., so as to make an Sn layer melt and Cu balls in the solder connected to each other. Then, the outer Sn layer is converted into a Cu-Sn intermetallic compound with high remelting temperature. Finally, a weld has high temperature resistance and thermal cycle resistance, which is not suitable for connection at a low temperature of 150° C. Therefore, the development of a solder with low melting point and high thermal conductivity that can be used for solder pastes is of great significance.

### SUMMARY

Purposes of the present invention are to overcome the shortcomings of the prior art and provide a composite metal material. The composite metal material is a Cu@Ag@Sn core-shell metal powder or a Cu@Ni@Sn core-shell metal powder. An Sn shell layer is not melted or is finitely melted during reflux, so that a Cu core and an Ag or Ni intermediate layer are prevented from being dissolved or are slightly dissolved. Moreover, the production of an intermetallic compound (Cu₆Sn₅) with high thermal resistance in the inner layer is reduced, so that the thermal conductivity of Sn—Bi series solders can be increased from 21.4 W/(m·K) to 50.82 W/(m·K) at 85° C., and the melting point of the SN-Bi series solders is only 138.9° C. Such solders are suitable for welding at low temperature, the problem of contradiction between high thermal conductivity and low melting point of solders is solved, and the advantages of high thermal conductivity and low-temperature melting are combined.

The present invention further provides a low-temperature solder paste with high thermal conductivity containing the composite metal material. The solder paste has high practicability, and poor heat dissipation and other problems of power devices after die bonding caused by low thermal conductivity of current solder pastes on the market are solved.

Specific solutions are as follows.

A composite metal material is provided. The composite metal material is spherical, has a diameter of 20-60 μm and a three-layer core-shell structure, and includes a Cu core, an Ag or Ni intermediate layer and an Sn shell layer. In specific embodiments, the composite metal material is perfectly spherical, and the diameter of the composite metal material may be 25-55 μm, such as 30 μm, 35 μm, 40 μm, 42 μm, 45 μm, 48 μm, 50 μm, 52 μm or 54 μm. The composite metal material with the structure has good structural stability and has the effect of improving the thermal conductivity of a solder in the solder, so that the thermal conductivity of a product is improved.

Further, the diameter of the core is 15-60 μm, preferably 20-50 μm, and may be 25 μm, 30 μm, 33 μm, 35 μm, 38 μm, 40 μm, 45 μm or 48 μm; the thickness of the intermediate layer is 0.5-2 μm, preferably 0.8-1.8 μm, and may be 1.0 μm, 1.2 μm, 1.4 μm, 1.5 μm, 1.6 μm or 1.7 μm; and the thickness of the shell layer is 0.5-2 μm, preferably 0.8-1.8 μm, and may be 0.9 μm, 1.0 μm, 1.2 μm, 1.3 μm, 1.4 μm, 1.5 μm, 1.6 μm or 1.7 μm. By using the composite metal material with optimized thickness of 3 layers, the effect of protecting the core can be better achieved, and the production of Cu₆Sn₅ is effectively prevented during heating, so that the thermal conductivity of a solder is obviously improved.

Further, the content of Cu is 60-98% of the total weight of the composite metal material by weight, preferably 65-95%, and may be 70%, 73%, 75%, 76%, 78%, 80%, 82%, 85%, 88% or 90%; the content of Ag or Ni is 1-20% of the total weight, preferably 3-18%, and may be 4%, 6%, 8%, 9%, 10%, 11%, 12%, 13%, 14%, 15%, 16% or 17%; and the content of Sn is 1-20% of the total weight, preferably 3-18%, and may be 4%, 6%, 8%, 9%, 10%, 11%, 12%, 13%, 14%, 15%, 16% or 17%. Through proportional collocation of the 3 elements, a solder may still be welded at a low temperature of 139° C. while the thermal conductivity is improved, so that the thermal conductivity of the solder is improved.

The present invention further protects a preparation method of the composite metal material. The composite metal material is a Cu@Ag@Sn core-shell metal powder. The method includes the following preparation processes:
S1: subjecting a Cu powder to acid pickling, followed by dispersion in distilled water to form a mixed solution A;
S2: adding a reductant and a stabilizer into the solution A for ultrasonic dispersion, and adding an oleylamine to obtain a mixed solution B; and pouring the mixed solution B into a reactor to carry out a heating reaction, collecting a reaction product, and rinsing the reaction product, followed by dispersion in distilled water to obtain a mixed solution C;
S3: adding a complexing agent, a brightener, silver nitrate and a pH regulator into the mixed solution C for uniform mixing to obtain a mixed solution D; and subjecting the mixed solution D to a heat preservation reaction, collecting a reaction product, and rinsing the reaction product, followed by dispersion in distilled water to obtain a mixed solution E; and
S4: adding a dispersant, a coordination agent and an Sn powder into the mixed solution E to carry out a stirring reaction, collecting a product after the reaction is completed, and rinsing the product, followed by drying to obtain the Cu@Ag@Sn core-shell metal powder.

Further, in S1, the Cu powder with a particle size of 15-60 μm is selected with a screen mesh, subjected to ultrasonic acid pickling and then uniformly dispersed in the distilled water to form the mixed solution A, so as to make the concentration of the Cu powder reach 1-3 g/mL. For example, the concentration of the Cu powder may be 1.5 g/mL, 2.0 g/mL or 2.5 g/mL. Preferably, the acid pickling is conducted by using any one of nitric acid, hydrochloric acid or sulfuric acid with a mass concentration of 2-5%.

Optionally, in S2, the reductant is a formate and is selected from one of sodium formate, potassium formate and calcium formate, and the concentration of the reductant in the mixed solution B is 0.1-0.2 g/mL; the stabilizer is selected from one of N,N-dimethylformamide, glycerol and propylene glycol, and the added amount of the stabilizer is 60-80% of the volume of the mixed solution B; the added amount of the oleylamine is 3-6% of the volume of the mixed solution B; preferably, the heating reaction is carried out under heat preservation at 120-200° C. for 10-20 hours, and magnetic stirring is conducted at a rotation speed of 100-500 rpm during the heat preservation; the rinsing is conducted alternately with distilled water and ethanol for 2-3 times; and the concentration of the mixed solution C is 5-10 g/mL.

Optionally, in S3, the complexing agent is selected from at least one of N-β-hydroxyethyl ethylenediamine triacetic acid, imidazole, citric acid, tartaric acid and gluconic acid, and the concentration of the complexing agent in the mixed solution D is 0.03-0.05 g/mL; the brightener is selected from one of glycerol, ethylene glycol and glycine, and the concentration of the brightener in the mixed solution D is 0.003-0.005 g/mL; the concentration of the silver nitrate in the mixed solution D is 0.004-0.006 g/mL; the pH regulator is selected from at least one of nitric acid and hydrochloric acid and is used for adjusting the pH of the mixed solution D to 3-4; preferably, the heat preservation reaction is carried out under heat preservation at 40-70° C. for 2-8 minutes, and magnetic stirring is conducted at a rotation speed of 100-200 rpm during the heat preservation; and the concentration of the mixed solution E is 0.1-0.3 g/mL.

Optionally, in S4, the dispersant is selected from at least one of paraffin wax, polyvinylpyrrolidone and polyethylene glycol, and the concentration of the dispersant in the mixed solution E is 0.1-0.2 g/mL; the coordination agent is selected from at least one of ammonium thiocyanate and thiourea, and the concentration of the coordination agent in the mixed solution E is 0.1-0.2 g/mL; the concentration of the Sn powder in the mixed solution E is 0.03-0.06 g/mL; preferably, the stirring reaction is carried out under stirring at a rotation speed of 100-200 rpm at room temperature for 5-10 minutes; and the collected product is rinsed with distilled water for 2-3 times and dried at 50-70° C. for 30-60 minutes to obtain the Cu@Ag@Sn core-shell metal powder.

As another case of the present invention, the composite metal material is a Cu@Ni@Sn core-shell metal powder and is prepared by the following processes:
P1: subjecting a Cu powder to acid pickling, followed by dispersion in distilled water to form a mixed solution A;
P2: adding a reductant and a stabilizer into the solution A for ultrasonic dispersion, and adding an oleylamine to obtain a mixed solution B; and pouring the mixed solution B into a reactor to carry out a heating reaction, collecting a reaction product, and rinsing the reaction product to obtain a product C;
P3: adding a nickel salt, a reductant, a stabilizer, an accelerator and a pH regulator into an eutectic solvent for dissolution to obtain a plating solution D, where the eutectic solvent includes a hydrogen bond receptor and a hydrogen bond donor;
P4: placing the product C in the plating solution D for electroless nickel plating, collecting a product after the plating is completed, and rinsing the product, followed by dispersion in distilled water to obtain a mixed solution F; and
P5: adding a dispersant, a coordination agent and an Sn powder into the mixed solution F to carry out a stirring reaction, collecting a product after the reaction is completed, and rinsing the product, followed by drying to obtain the Cu@Ni@Sn core-shell metal powder.

Further, in P1, the Cu powder with a particle size of 15-60 μm is selected with a screen mesh, subjected to ultrasonic acid pickling and then uniformly dispersed in the distilled water to form the mixed solution A, so as to make the concentration of the Cu powder reach 1-3 g/mL. Preferably, the acid pickling is conducted by using any one of nitric acid, hydrochloric acid or sulfuric acid with a mass concentration of 2-5%.

Optionally, in P2, the reductant is a formate and is selected from one of sodium formate, potassium formate and calcium formate, and the concentration of the reductant in the mixed solution B is 0.1-0.2 g/mL; the stabilizer is selected from one of N,N-dimethylformamide, glycerol and propylene glycol, and the added amount of the stabilizer is 60-80% of the volume of the mixed solution B; the added amount of the oleylamine is 3-6% of the volume of the mixed solution B; preferably, the heating reaction is carried out under heat preservation at 120-200° C. for10-20 hours, and magnetic stirring is conducted at a rotation speed of 100-500 rpm during the heat preservation; the rinsing is conducted alternately with distilled water and ethanol for 2-3 times; and the concentration of the mixed solution C is 5-10 g/mL.

Optionally, in P3, the nickel salt is a combination of one or more of nickel chloride, nickel sulfate, nickel acetate and nickel aminosulfonate, and the concentration of the nickel salt is 5-50 g/L; the reductant is selected from one of hydrazine, sodium hypophosphite, sodium borohydride, potassium borohydride and dimethylamine borane, and the concentration of the reductant is 1-30 g/L; the stabilizer is one or more of boric acid, citric acid, lactic acid, sodium potassium tartrate and disodium ethylenediamine tetraacetic acid, and the concentration of the stabilizer is 0.5-15 g/L; the accelerator is one or more of ethanolamine, diethanolamine, triethanolamine, N-methyldiethanolamine and N,N-dimethylethanolamine, and the concentration of the accelerator is 5-20 g/L; the pH regulator is a 5 wt % sodium hydroxide-ethylene glycol solution, and the pH range is 7.0-14.0; and preferably, the hydrogen bond receptor in the eutectic solvent is a combination of one or more of choline chloride, tetramethylammonium chloride, tetrabutylammonium chloride, tetraethylammonium chloride and derivatives thereof, the hydrogen bond donor is a combination of one or two of a polyol, an amide and a carboxylic acid, the molar ratio of the hydrogen bond receptor to the hydrogen bond donor is 1:1 to 1:5, and the eutectic solvent is obtained by mixing the two substances under stirring at 60-90° C. for 2-4 hours.

Optionally, in P4, the electroless nickel plating is conducted at a temperature of 60-150° C. and a pH of 7.0-14.0 for 0.5-4.0 hours; magnetic stirring is conducted at a rotation speed of 100-200 rpm during the electroless nickel plating; and after a reaction is completed, the product is collected and rinsed with distilled water for 2-3 times. The rinsed product is dispersed in distilled water to obtain the mixed solution F with a concentration of 0.1-0.3 g/mL.

Optionally, in P5, the dispersant is selected from at least one of paraffin wax, polyvinylpyrrolidone and polyethylene glycol, and the concentration of the dispersant in the mixed solution F is 0.1-0.2 g/mL; the coordination agent is selected from at least one of ammonium thiocyanate and thiourea, and the concentration of the coordination agent in the mixed solution F is 0.1-0.2 g/mL; the concentration of the Sn powder in the mixed solution F is 0.03-0.06 g/mL; the stirring reaction is carried out under stirring at a rotation speed of 100-200 rpm at room temperature for 5-10 minutes; and the collected product is rinsed with distilled water for 2-3 times and dried at 50-70° C. for 30-60 minutes to obtain the Cu@Ni@Sn core-shell metal powder.

The present invention further protects a low-temperature solder paste with high thermal conductivity containing the composite metal material. The low-temperature solder paste with high thermal conductivity includes the composite metal material, an Sn—Bi series alloy powder and a flux paste. The content of the composite metal material is 10-30% of the total weight, preferably 12-28%. For example, the content of the composite metal material may be 14%, 16%, 18%, 19%, 20%, 21%, 23%, 25% or 26%. The content of the Sn—Bi series alloy powder is 10-30% of the total weight, preferably 12-28%. For example, the content of the Sn—Bi series alloy powder may be 14%, 16%, 18%, 19%, 20%, 21%, 23%, 25% or 26%.

Further, the flux paste is a medium- and low-temperature rosin-based flux paste. The low temperature herein indicates that the welding temperature of a solder is lower than 150° C., and specifically indicates that the melting point of a solder is 138-140° C. The rosin-based flux paste is a paste prepared by dissolving rosin as a carrier and an organic acid in an organic solvent under the presence of a thixotropic agent, and may be a common rosin-base flux paste in the art.

Optionally, the Sn—Bi series alloy powder is selected from at least one of a hypo-eutectic Sn—Bi alloy powder, an eutectic Sn-58Bi alloy powder and a hyper-eutectic Sn—Bi alloy powder with a particle size of 20-60 μm; the particle size is preferably 25-55 μm. For example, the particle size may be 28 μm, 30 μm, 32 μm, 35 μm, 38 μm, 40 μm, 41 μm, 42 μm, 45 μm, 48 μm, 50 μm or 53 μm.

Optionally, the low-temperature solder paste with high thermal conductivity has an initial melting point of 138-140° C., a peak temperature of 140-145° C. and a thermal conductivity of 50-55 W/(m·K). In specific embodiments, the initial melting point of the low-temperature solder paste with high thermal conductivity is 138.5° C., 139.0° C., 139.5° C. or 139.8° C.; the peak temperature is 140.5° C., 141.0° C., 141.5° C., 142.0° C., 142.5° C., 143.0° C., 143.5° C. or 144° C.; and the thermal conductivity is 50.5 W/(m K), 51.0 W/(m K), 51.5 W/(m K), 52.0 W/(m K), 52.5 W/(m K), 53.0 W/(m K), 54.0 W/(m K) or 54.5 W/(m K).

The present invention further protects a device. The device is obtained by welding with the low-temperature solder paste with high thermal conductivity.

### Beneficial Effects

1. According to the present invention, the surface of a Cu powder is coated with an Ag or Ni intermediate layer and an Sn shell layer by a multilayer electroless plating process first to obtain Cu@Ag@Sn core-shell structure particles and Cu@Ni@Sn core-shell structure particles with good morphology. Not only are the defects of easy oxidation and difficult storage of current Cu powders in the air overcome, but also the Ag or Ni intermediate layer and the Sn shell layer can effectively protect the Cu core, the Ag or Ni intermediate layer is not dissolved or is slightly dissolved, and the production of an intermetallic compound (Cu₆Sn₅) with high thermal resistance in the inner layer is reduced, so that the thermal conductivity of a solder is obviously improved.

2. Compared with Sn—Bi series solder pastes, the thermal conductivity of the low-temperature solder paste with high thermal conductivity prepared by the present invention is increased from 21.4 W/(m·K) to 50.82 W/(m·K) at 85° C., and the melting point of the solder is only 138.9° C. The solder paste is suitable for welding at low temperature, and poor heat dissipation and other problems of power devices after die bonding caused by low thermal conductivity of current solder pastes on the market are solved.

3. According to the low-temperature solder paste with high thermal conductivity prepared by the present invention, a connection can be formed during reflux, the process is simple, and the time for die bonding in a large area is greatly shortened.

4. The present invention has the advantages of simple process, low cost and high practicability, and pins can be prepared by selecting metal powders with different particle sizes and different coating amounts according to an actual use environment.

In conclusion, Cu@Ag@Sn core-shell metal particles and Cu@Ni@Sn core-shell metal particles with good morphology can be obtained by the present invention. As the Ag or Ni intermediate layer and the Sn shell layer are uniformly coated, the Cu core can be effectively protected, the Ag or Ni intermediate layer is not dissolved or is slightly dissolved, and the production of an intermetallic compound (Cu₆Sn₅) with high thermal resistance in the inner layer is reduced, so that the thermal conductivity of a solder is obviously improved.

### BRIEF DESCRIPTION OF DRAWINGS

In order to more clearly illustrate the technical solutions of the present invention, attached drawings are briefly introduced below. Obviously, the attached drawings described below relate to merely some embodiments of the present invention and are not intended to limit the present invention.

FIG. 1 shows a physical image of a welding object provided in the background of the present invention;

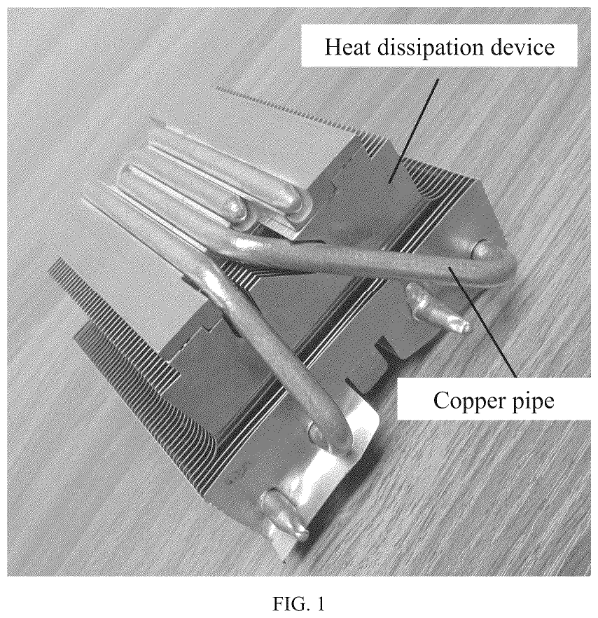

FIG. 2 shows a physical image and an X-ray diffraction spectrum of a Cu@Ag@Sn core-shell metal powder provided in Example 3 of the present invention;

FIG. 3 shows a scanning electron microscope image of Cu@Ag@Sn core-shell metal particles provided in Example 3 of the present invention;

FIG. 4 shows an energy spectrum area scanning image of the Cu@Ag@Sn core-shell metal particles provided in Example 3 of the present invention;

FIG. 5 shows an energy spectrum line scanning image of the cross section of the Cu@Ag@Sn core-shell metal particles provided in Example 3 of the present invention;

FIG. 6 shows a physical image of a low-temperature solder with high thermal conductivity provided in Example 7 of the present invention;

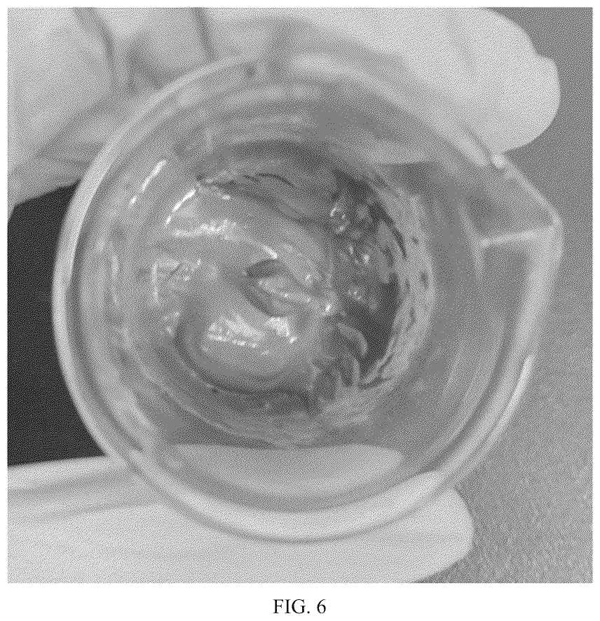

FIG. 7 shows a DSC curve of the low-temperature solder with high thermal conductivity provided in Example 7 of the present invention; and

FIG. 8 shows the thermal conductivity of the low-temperature solder with high thermal conductivity prepared in Example 7 of the present invention.

### DESCRIPTION OF EMBODIMENTS

Preferred embodiments of the present invention are described in more detail below. Although the preferred embodiments of the present invention are described below, it should be understood that the present invention can be implemented in various forms and is not limited by the embodiments described herein. Preparation without specific technologies or conditions in the embodiments is carried out according to technologies or conditions described in documents in the art or specifications of products. Reagents or instruments used without specific manufacturers are conventional products available on the market. In the following embodiments, unless otherwise specified, “%” indicates weight percentage.

A low-temperature non-lead type rosin-based flux paste used below is a halogen-free flux paste S8 purchased from Xiamen Jissyu Solder Co., Ltd.

### Example 1 Preparation of a Cu@Ag@Sn Core-Shell Metal Powder

S1: 20 g of a Cu powder with a particle size of 20 μm was selected with a screen mesh, subjected to ultrasonic cleaning with hydrochloric acid with a mass fraction of 2% for 5 minutes and then uniformly dispersed in 20 mL of distilled water to form a mixed solution A.

S2: 1.2 g of sodium formate and 72 mL of N,N-dimethylformamide were added into the mixed solution A for ultrasonic dispersion for 3 minutes, and 8 mL of an oleylamine was added to obtain a mixed solution B. Then the mixed solution B was poured into a high-pressure reactor and subjected to heat preservation at 150° C. for 18 hours, and magnetic stirring was conducted at a rotation speed of 200 rpm during the heat preservation. A reaction product was collected and rinsed alternately with distilled water and ethanol for 3 times. The rinsed product was dispersed in 200 mL of distilled water to obtain a mixed solution C.

S3: 6 g of N-β-hydroxyethyl ethylenediamine triacetic acid, 6 g of ethylene glycol and 8 g of silver nitrate were added into the mixed solution C, the pH was adjusted to 4 with hydrochloric acid with a mass fraction of 38%, and the solution was uniformly mixed to obtain a mixed solution D. The mixed solution D was subjected to heat preservation at 50° C. for 8 minutes, and magnetic stirring was conducted at a rotation speed of 100 rpm during the heat preservation. After the heat preservation was completed, a reaction product was collected and rinsed with distilled water for 3 times, and the rinsed product was dispersed in 200 mL of distilled water to obtain a mixed solution E.

S4: 20 g of paraffin wax, 20 g of ammonium thiocyanate and 6 g of a pure Sn powder were added into the mixed solution E and subjected to magnetic stirring at a rotation speed of 100 rpm at room temperature for 8 minutes to carry out a full reaction. After the reaction was completed, a product was collected and rinsed with distilled water for 3 times. Finally, the product was dried at 60° C. for 40 minutes to obtain a Cu@Ag@Sn core-shell metal powder.

### Example 2 Preparation of a Cu@Ag@Sn Core-Shell Metal Powder

S1: 20 g of a Cu powder with a particle size of 20 μm was selected with a screen mesh, subjected to ultrasonic cleaning with hydrochloric acid with a mass fraction of 2% for 5 minutes and then uniformly dispersed in 20 mL of distilled water to form a mixed solution A.

S2: 1.2 g of sodium formate and 72 mL of N,N-dimethylformamide were added into the mixed solution A for ultrasonic dispersion for 3 minutes, and 8 mL of an oleylamine was added to obtain a mixed solution B. Then the mixed solution B was poured into a high-pressure reactor and subjected to heat preservation at 150° C. for 18 hours, and magnetic stirring was conducted at a rotation speed of 200 rpm during the heat preservation. A reaction product was collected and rinsed alternately with distilled water and ethanol for 3 times. The rinsed product was dispersed in 200 mL of distilled water to obtain a mixed solution C.

S3: 10 g of N-β-hydroxyethyl ethylenediamine triacetic acid, 10 g of ethylene glycol and 12 g of silver nitrate were added into the mixed solution C, the pH was adjusted to 4 with hydrochloric acid with a mass fraction of 38%, and the solution was uniformly mixed to obtain a mixed solution D. The mixed solution D was subjected to heat preservation at 50° C. for 8 minutes, and magnetic stirring was conducted at a rotation speed of 100 rpm during the heat preservation. After the heat preservation was completed, a reaction product was collected and rinsed with distilled water for 3 times, and the rinsed product was dispersed in 200 mL of distilled water to obtain a mixed solution E.

S4: 20 g of paraffin wax, 20 g of ammonium thiocyanate and 6 g of a pure Sn powder were added into the mixed solution E and subjected to magnetic stirring at a rotation speed of 100 rpm at room temperature for 8 minutes to carry out a full reaction. After the reaction was completed, a product was collected and rinsed with distilled water for 3 times. Finally, the product was dried at 60° C. for 40 minutes to obtain a Cu@Ag@Sn core-shell metal powder.

### Example 3 Preparation of a Cu@Ag@Sn core-shell metal powder

S1: 20 g of a Cu powder with a particle size of 20 μm was selected with a screen mesh, subjected to ultrasonic cleaning with hydrochloric acid with a mass fraction of 2% for 5 minutes and then uniformly dispersed in 20 mL of distilled water to form a mixed solution A.

S2: 1.2 g of sodium formate and 72 mL of N,N-dimethylformamide were added into the mixed solution A for ultrasonic dispersion for 3 minutes, and 8 mL of an oleylamine was added to obtain a mixed solution B. Then the mixed solution B was poured into a high-pressure reactor and subjected to heat preservation at 150° C. for 18 hours, and magnetic stirring was conducted at a rotation speed of 200 rpm during the heat preservation. A reaction product was collected and rinsed alternately with distilled water and ethanol for 3 times. The rinsed product was dispersed in 200 mL of distilled water to obtain a mixed solution C.

S3: 6 g of N-β-hydroxyethyl ethylenediamine triacetic acid, 6 g of ethylene glycol and 8 g of silver nitrate were added into the mixed solution C, the pH was adjusted to 4 with hydrochloric acid with a mass fraction of 38%, and the solution was uniformly mixed to obtain a mixed solution D. The mixed solution D was subjected to heat preservation at 50° C. for 8 minutes, and magnetic stirring was conducted at a rotation speed of 100 rpm during the heat preservation. After the heat preservation was completed, a reaction product was collected and rinsed with distilled water for 3 times, and the rinsed product was dispersed in 200 mL of distilled water to obtain a mixed solution E.

S4: 40 g of paraffin wax, 40 g of ammonium thiocyanate and 12 g of a pure Sn powder were added into the mixed solution E and subjected to magnetic stirring at a rotation speed of 100 rpm at room temperature for 8 minutes to carry out a full reaction. After the reaction was completed, a product was collected and rinsed with distilled water for 3 times. Finally, the product was dried at 60° C. for 40 minutes to obtain a Cu@Ag@Sn core-shell metal powder.

### Example 4 Preparation of a Cu@Ni@Sn Core-Shell Metal Powder

P1: 20 g of a Cu powder with a particle size of 20 μm was selected with a screen mesh, subjected to ultrasonic cleaning with hydrochloric acid with a mass fraction of 2% for 5 minutes and then uniformly dispersed in 20 mL of distilled water to form a mixed solution A.

P2: 1.2 g of sodium formate and 72 mL of N,N-dimethylformamide were added into the mixed solution A for ultrasonic dispersion for 3 minutes, and 8 mL of an oleylamine was added to obtain a mixed solution B. Then the mixed solution B was poured into a high-pressure reactor and subjected to heat preservation at 150° C. for 18 hours, and magnetic stirring was conducted at a rotation speed of 200 rpm during the heat preservation. A reaction product was collected and rinsed alternately with distilled water and ethanol for 3 times to obtain a product C.

P3: 25 g/L of nickel chloride, 15 g/L of sodium hypophosphite, 10 g/L of citric acid and 10 g/L of triethanolamine were dissolved in an eutectic solvent of choline chloride and ethylene glycol at a molar ratio of 1:2, the pH was adjusted to 9.0 with a 5 wt % NaOH-ethylene glycol solution, and the substances were stirred for dissolution to obtain an electroless plating solution D.

P4: The product C was placed in the electroless plating solution D for plating at a temperature of 60° C. for 2 hours. During the plating, magnetic stirring was conducted at a rotation speed of 100-200 rpm to carry out a full reaction. After the reaction was completed, a product was collected and rinsed with distilled water for 3 times. The rinsed product was dispersed in distilled water to obtain a mixed solution F with a concentration of 0.2 g/mL.

P5: 40 g of paraffin wax, 40 g of ammonium thiocyanate and 12 g of a pure Sn powder were added into the mixed solution F and subjected to magnetic stirring at a rotation speed of 100 rpm at room temperature for 8 minutes to carry out a full reaction. After the reaction was completed, a product was collected and rinsed with distilled water for 3 times. Finally, the product was dried at 60° C. for 40 minutes to obtain a Cu@Ni@Sn core-shell metal powder.

### Example 5 Preparation of a Solder Paste

The Cu@Ag@Sn core-shell metal powder prepared in Example 1 was mixed with a commercially available eutectic Sn-58Bi alloy powder with a diameter of 45 μm at a mass ratio of 1:8, and then mixed with a low-temperature lead-free type rosin-based flux paste. The mixing process was carried out at room temperature, and the metal powder was added gradually by quantity under stirring until a paste, namely a low-temperature solder paste with high thermal conductivity was formed, where according to the mixing ratio, the content of the Cu@Ag@Sn core-shell metal powder was 10% of the total mass of the solder paste, and the flux paste was 10% of the total mass of the solder paste.

### Example 6 Preparation of a Solder Paste

The Cu@Ag@Sn core-shell metal powder prepared in Example 2 was mixed with a commercially available eutectic Sn-58Bi alloy powder with a diameter of 45 μm at a mass ratio of 2:7, and then mixed with a low-temperature lead-free type rosin-based flux paste. The mixing process was carried out at room temperature, and the metal powder was added gradually by quantity under stirring until a paste, namely a low-temperature solder paste with high thermal conductivity was formed, where according to the mixing ratio, the content of the Cu@Ag@Sn core-shell metal powder was 20% of the total mass of the solder paste, and the flux paste was 10% of the total mass of the solder paste.

### Example 7 Preparation of a Solder Paste

The Cu@Ag@Sn core-shell metal powder prepared in Example 3 was mixed with a commercially available eutectic Sn-58Bi alloy powder with a diameter of 45 μm at a mass ratio of 3:6, and then mixed with a low-temperature lead-free type rosin-based flux paste. The mixing process was carried out at room temperature, and the metal powder was added gradually by quantity under stirring until a paste, namely a low-temperature solder paste with high thermal conductivity was formed, where according to the mixing ratio, the content of the Cu@Ag@Sn core-shell metal powder was 30% of the total mass of the solder paste, and the flux paste was 10% of the total mass of the solder paste.

### Example 8

The Cu@Ni@Sn core-shell metal powder prepared in Example 4 was mixed with a commercially available eutectic Sn-58Bi alloy powder with a diameter of 45 μm at a mass ratio of 1:8, and then mixed with a low-temperature lead-free type rosin-based flux paste. The mixing process was carried out at room temperature, and the metal powder was added gradually by quantity under stirring until a paste, namely a low-temperature solder paste with high thermal conductivity was formed, where according to the mixing ratio, the content of the Cu@Ni@Sn core-shell metal powder was 10% of the total mass of the solder paste, and the flux paste was 10% of the total mass of the solder paste.

### Example 9 Preparation of a Cu@Ag@Sn Core-Shell Metal Powder

S1: 20 g of a Cu powder with a particle size of 50 μm was selected with a screen mesh, subjected to ultrasonic cleaning with hydrochloric acid with a mass fraction of 2% for 5 minutes and then uniformly dispersed in 20 mL of distilled water to form a mixed solution A.

S2: 1.5 g of sodium formate and 72 mL of N,N-dimethylformamide were added into the mixed solution A for ultrasonic dispersion for 3 minutes, and 8 mL of an oleylamine was added to obtain a mixed solution B. Then the mixed solution B was poured into a high-pressure reactor and subjected to heat preservation at 200° C. for 10 hours, and magnetic stirring was conducted at a rotation speed of 200 rpm during the heat preservation. A reaction product was collected and rinsed alternately with distilled water and ethanol for 3 times. The rinsed product was dispersed in 200 mL of distilled water to obtain a mixed solution C.

S3: 5 g of imidazole, 7 g of ethylene glycol and 7 g of silver nitrate were added into the mixed solution C, the pH was adjusted to 4 with hydrochloric acid with a mass fraction of 38%, and the solution was uniformly mixed to obtain a mixed solution D. The mixed solution D was subjected to heat preservation at 50° C. for 8 minutes, and magnetic stirring was conducted at a rotation speed of 100 rpm during the heat preservation. After the heat preservation was completed, a reaction product was collected and rinsed with distilled water for 3 times, and the rinsed product was dispersed in 200 mL of distilled water to obtain a mixed solution E.

S4: 25 g of polyethylene glycol, 25 g of ammonium thiocyanate and 5 g of a pure Sn powder were added into the mixed solution E and subjected to magnetic stirring at a rotation speed of 100 rpm at room temperature for 8 minutes to carry out a full reaction. After the reaction was completed, a product was collected and rinsed with distilled water for 3 times. Finally, the product was dried at 60° C. for 40 minutes to obtain a Cu@Ag@Sn core-shell metal powder.

### Example 10 Preparation of a Cu@Ag@Sn Core-Shell Metal Powder

S1: 20 g of a Cu powder with a particle size of 30 μm was selected with a screen mesh, subjected to ultrasonic cleaning with hydrochloric acid with a mass fraction of 2% for 5 minutes and then uniformly dispersed in 20 mL of distilled water to form a mixed solution A.

S2: 1.2 g of sodium formate and 80 mL of N,N-dimethylformamide were added into the mixed solution A for ultrasonic dispersion for 3 minutes, and 8 mL of an oleylamine was added to obtain a mixed solution B. Then the mixed solution B was poured into a high-pressure reactor and subjected to heat preservation at 120° C. for 20 hours, and magnetic stirring was conducted at a rotation speed of 200 rpm during the heat preservation. A reaction product was collected and rinsed alternately with distilled water and ethanol for 3 times. The rinsed product was dispersed in 200 mL of distilled water to obtain a mixed solution C.

S3: 6 g of tartaric acid, 6 g of glycerol and 8 g of silver nitrate were added into the mixed solution C, the pH was adjusted to 4 with hydrochloric acid with a mass fraction of 38%, and the solution was uniformly mixed to obtain a mixed solution D. The mixed solution D was subjected to heat preservation at 50° C. for 8 minutes, and magnetic stirring was conducted at a rotation speed of 100 rpm during the heat preservation. After the heat preservation was completed, a reaction product was collected and rinsed with distilled water for 3 times, and the rinsed product was dispersed in 200 mL of distilled water to obtain a mixed solution E.

S4: 20 g of polyvinylpyrrolidone, 20 g of thiourea and 8 g of a pure Sn powder were added into the mixed solution E and subjected to magnetic stirring at a rotation speed of 100 rpm at room temperature for 8 minutes to carry out a full reaction. After the reaction was completed, a product was collected and rinsed with distilled water for 3 times. Finally, the product was dried at 60° C. for 40 minutes to obtain a Cu@Ag@Sn core-shell metal powder.

### Example 11 Preparation of a Cu@Ni@Sn Core-Shell Metal Powder

P1: 20 g of a Cu powder with a particle size of 50 μm was selected with a screen mesh, subjected to ultrasonic cleaning with hydrochloric acid with a mass fraction of 2% for 5 minutes and then uniformly dispersed in 20 mL of distilled water to form a mixed solution A.

P2: 1.0 g of potassium formate and 80 mL of propylene glycol were added into the mixed solution A for ultrasonic dispersion for 3 minutes, and 8 mL of an oleylamine was added to obtain a mixed solution B. Then the mixed solution B was poured into a high-pressure reactor and subjected to heat preservation at 200° C. for 10 hours, and magnetic stirring was conducted at a rotation speed of 200 rpm during the heat preservation. A reaction product was collected and rinsed alternately with distilled water and ethanol for 3 times to obtain a product C.

P3: 15 g/L of nickel acetate, 15 g/L of dimethylamine borane, 10 g/L of citric acid and 10 g/L of N-methyldiethanolamine were dissolved in an eutectic solvent of choline chloride and ethylene glycol at a molar ratio of 1:2, the pH was adjusted to 9.0 with a 5 wt % NaOH-ethylene glycol solution, and the substances were stirred for dissolution to obtain an electroless plating solution D.

P4: The product C was placed in the electroless plating solution D for plating at a temperature of 120° C. for 2 hours. During the plating, magnetic stirring was conducted at a rotation speed of 100-200 rpm to carry out a full reaction. After the reaction was completed, a product was collected and rinsed with distilled water for 3 times. The rinsed product was dispersed in distilled water to obtain a mixed solution F with a concentration of 0.1 g/mL.

P5: 50 g of polyethylene glycol, 40 g of ammonium thiocyanate and 16 g of a pure Sn powder were added into the mixed solution F and subjected to magnetic stirring at a rotation speed of 100 rpm at room temperature for 8 minutes to carry out a full reaction. After the reaction was completed, a product was collected and rinsed with distilled water for 3 times.

Finally, the product was dried at 60° C. for 40 minutes to obtain a Cu@Ni@Sn core-shell metal powder.

### Example 12 Preparation of a Cu@Ni@Sn Core-Shell Metal Powder

P1: 20 g of a Cu powder with a particle size of 40 μm was selected with a screen mesh, subjected to ultrasonic cleaning with hydrochloric acid with a mass fraction of 2% for 5 minutes and then uniformly dispersed in 20 mL of distilled water to form a mixed solution A.

P2: 1.5 g of calcium formate and 70 mL of propylene glycol were added into the mixed solution A for ultrasonic dispersion for 3 minutes, and 8 mL of an oleylamine was added to obtain a mixed solution B. Then the mixed solution B was poured into a high-pressure reactor and subjected to heat preservation at 120° C. for 20 hours, and magnetic stirring was conducted at a rotation speed of 200 rpm during the heat preservation. A reaction product was collected and rinsed alternately with distilled water and ethanol for 3 times to obtain a product C.

P3: 20 g/L of nickel sulfate, 12 g/L of sodium borohydride, 15 g/L of boric acid and 15 g/L of diethanolamine were dissolved in an eutectic solvent of choline chloride and ethylene glycol at a molar ratio of 1:2, the pH was adjusted to 9.0 with a 5 wt % NaOH-ethylene glycol solution, and the substances were stirred for dissolution to obtain an electroless plating solution D.

P4: The product C was placed in the electroless plating solution D for plating at a temperature of 100° C. for 2 hours. During the plating, magnetic stirring was conducted at a rotation speed of 100-200 rpm to carry out a full reaction. After the reaction was completed, a product was collected and rinsed with distilled water for 3 times. The rinsed product was dispersed in distilled water to obtain a mixed solution F with a concentration of 0.3 g/mL.

P5: 45 g of polyvinylpyrrolidone, 35 g of thiourea and 15 g of a pure Sn powder were added into the mixed solution F and subjected to magnetic stirring at a rotation speed of 100 rpm at room temperature for 8 minutes to carry out a full reaction. After the reaction was completed, a product was collected and rinsed with distilled water for 3 times. Finally, the product was dried at 60° C. for 40 minutes to obtain a Cu@Ni@Sn core-shell metal powder.

### Comparative Example 1 Addition of a Porous Foamy Cu Sheet into an Sn58Bi Alloy

A porous foamy Cu sheet was impregnated in a molten Sn58Bi solder by referring to Liu, Yang, et al. Journal of Materials Science: Materials in Electronics. 2020, 31, 8258-8267. A composite solder sheet was prepared, and then the thermal conductivity was tested. Specific steps are as follows.

S1: Porous foamy Cu having 500 holes per inch (500 ppi), a porosity of 85% and a thickness of 0.05 mm was selected.

S2: The porous foamy Cu was impregnated in a molten Sn58Bi solder at 250° C. for 7 seconds and taken out, followed by cooling at room temperature to obtain a composite solder sheet.

S3: The composite solder sheet was prepared into a round sample with a diameter of 12.7 mm and a thickness of 2 mm, and then the thermal conductivity was tested by NETZSCH LFA 447.

The composite solder sheet prepared by impregnating the porous foamy Cu sheet in the Sn58Bi according to the method has a thermal conductivity of 41.32 W/(m·K). Compared with existing methods, the thermal conductivity of the low-temperature solder paste with high thermal conductivity prepared in Example 7 of this application can reach 50.82 W/(m·K).

### Comparative Example 2 Addition of Cu Particles into an Sn58Bi Solder Paste

5 wt. % Cu particles were added into an Sn58Bi solder paste by referring to Hao Zhang, et al. Journal of Materials Science: Materials in Electronics. 2019, 30:340-347. A composite solder paste was prepared, and then the thermal conductivity was tested. Specific steps are as follows.

S1: Cu particles with an average diameter of 5 μm and Sn58Bi particles with an average diameter of 45 μm were selected for mixing, a flux was added, and mechanical stirring was conducted for 30 minutes to obtain a composite flux paste.

S2: The composite flux paste was coated on an aluminum substrate with a copper pad and a circuit, the aluminum substrate was placed under a 3535 LED lamp for heating at a peak temperature of 170° C., and the 3535 LED lamp was welded on the substrate to form a weld joint.

S3: Thermal behaviors of the welded LED lamp and the thermal conductivity of an Sn58Bi-5 wt. % Cu solder layer were evaluated by T3Ster.

The Sn58Bi-5 wt. % Cu composite solder prepared by the method has a peak temperature of 170° C. during welding, and the Sn58Bi-5 wt. % Cu solder layer has a thermal conductivity of 26.60 W/(m·K). Compared with existing methods, the low-temperature solder paste with high thermal conductivity prepared in Example 7 of this application has a melting point of 138.9° C., a welding temperature not higher than 150° C. and a thermal conductivity of 50.82 W/(m·K).

### Comparative Example 3 Cu@Sn Composite Solder Sheet

Cu@Sn core-shell metal particles were formed by plating Sn on the surfaces of Cu particles, and then the Cu@Sn core-shell metal particles were pressed at a pressure of 30 MPa to obtain a composite solder sheet with a size of 400±20 μm (Hongtao Chen, Tianqi Hu, et al. IEEE Transactions on Power Electronics. 2017, 32(1): 441-51.). Then the thermal conductivity was tested. Specific steps are as follows.

S1: Thiourea (0.65 mol/L), EDTA (0.0014 mol/L), hydroquinone (0.0036 mol/L) and sodium hypophosphite (0.2 mol/L) were dissolved in 80 mL of deionized water at room temperature, then methanesulfonic acid (0.0042 mol/L) and ethylene glycol (15 mL/L) were added, and the solution was stirred gently until the materials were completely dissolved to obtain a mixed solution A.

S2:2 g of stannous chloride was dissolved in 1 mL of a hydrochloric acid solution to obtain a mixed solution B.

S3:2 g of a Cu particle powder with an average diameter of 35 μm was dropped into an ethanol solution containing 5% hydrochloric acid, the solution was subjected to ultrasonic cleaning to remove contaminants and oxide layers on the surfaces of Cu particles, and finally, the Cu particles were washed with deionized water for four times.

S4: The solution B was poured into the solution A and stirred continuously until the solution was uniformly mixed. Then the pickled Cu particles were quickly added into the mixed solution. The mixed solution was continuously stirred at room temperature for 3 hours, followed by filtration to obtain Cu@Sn core-shell particles.

S5: The Cu@Sn core-shell metal particles were pressed at a pressure of 30 MPa for 1 minute to obtain a composite solder sheet with a size of 400±20 μm.

S6: The thermal diffusion coefficient and specific heat capacity of the composite solder sheet were tested by NETZSCH 477 and NETZSCH STA 449F3, respectively, and finally, the obtained diffusion coefficient, the specific heat capacity and the density were multiplied to obtain the thermal conductivity of the composite solder sheet.

The Cu@Sn composite solder sheet prepared by the method has a thermal conductivity of 154.26 W/(m·K) at 30° C., 130.64 W/(m·K) at 150° C. and 127.99 W/(m·K) at 250° C. The welding is conducted at a reflux temperature of 250° C., and the composite solder sheet is not suitable for welding at a low temperature of 150° C. Compared with existing methods, the low-temperature solder paste with high thermal conductivity prepared in Example 7 of this application has a melting point of 138.9° C., a welding temperature not higher than 150° C. and a thermal conductivity of 50.82 W/(m·K).

### Performance test

### (1) Morphology of a Composite Material

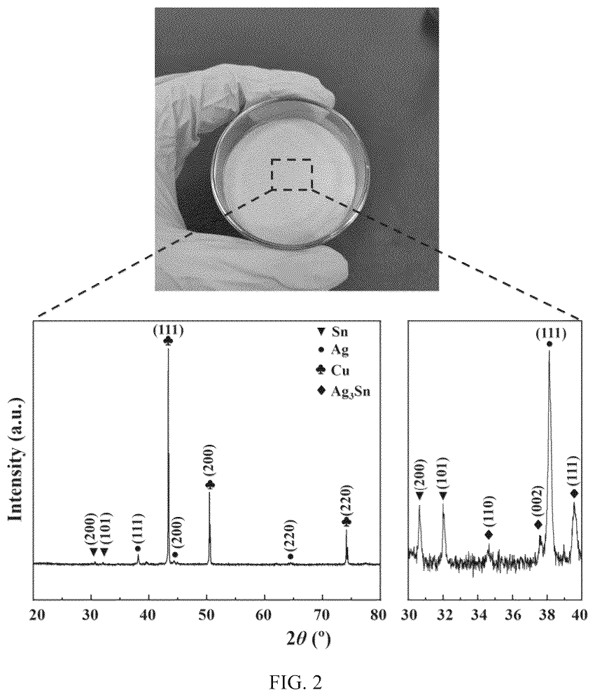

The composite metal material prepared in Example 3 was analyzed. FIG. 2 shows a Cu@Ag@Sn metal powder and an XRD spectrum thereof. From the figure, the Ag, the Sn and a compound (Ag₃Sn) formed by Ag atoms and Sn atoms can be seen, indicating that the surfaces of Cu particles are successfully coated with an Ag layer and an Sn layer.

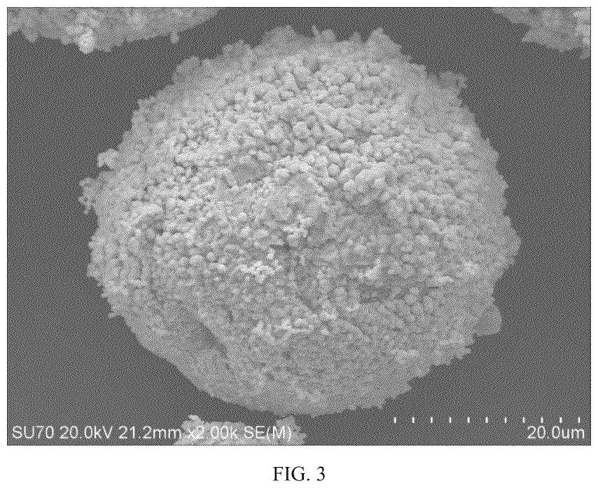

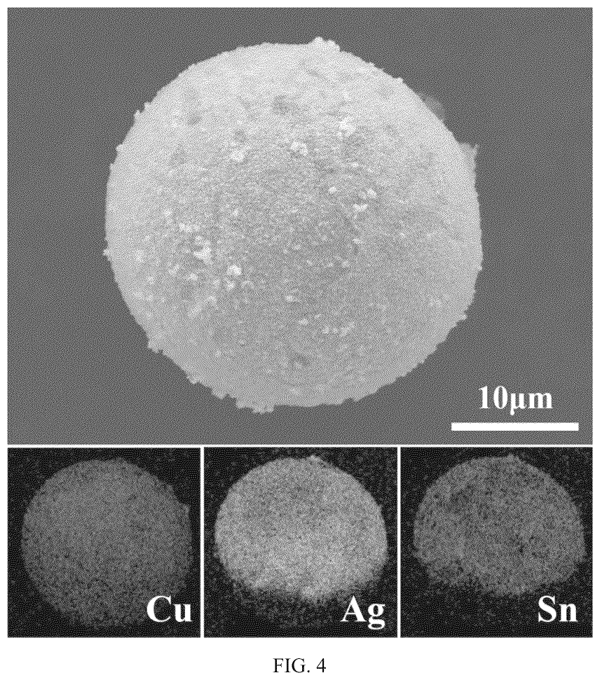

FIG. 3 and FIG. 4 show a scanning electron microscope image and an energy spectrometer area scanning image of Cu@Ag@Sn core-shell metal particles, respectively. The results show that after electroless plating of Ag and Sn on the Cu particles, thick plating layers formed by the Ag atoms and the Sn atoms are deposited on the surfaces of the Cu particles, and the surfaces of the Cu@Ag@Sn core-shell metal particles are rough and pitted.

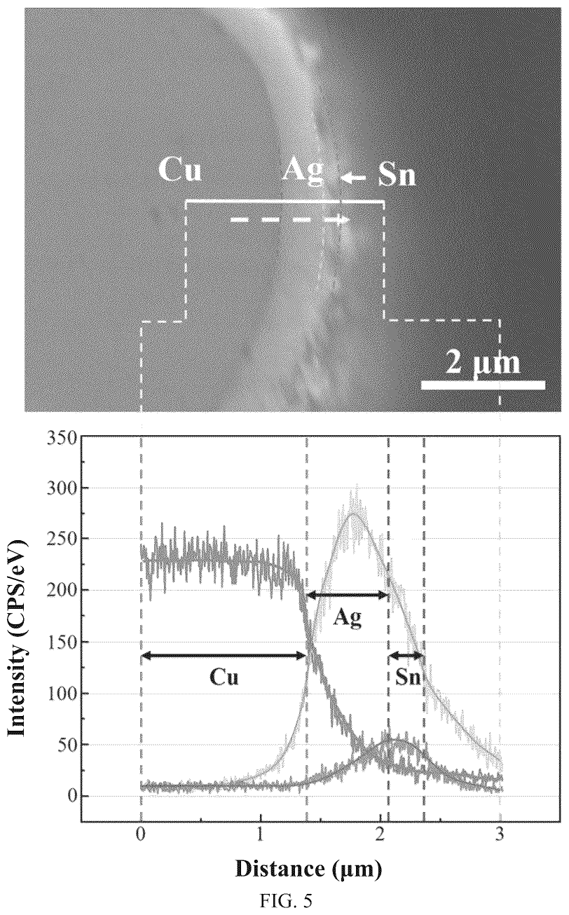

FIG. 5 shows a local energy spectrometer line scanning image of the cross section of the Cu@Ag@Sn core-shell metal particles. From the figure, it can be clearly observed that the Ag intermediate layer and the Sn shell layer are closely bound to the Cu core without pores after electroless plating for two times. The energy spectrum line scanning results show that the Ag and the Sn have fluctuated intensity in different plating layers, proving that the plating layers are the Ag layer and the Sn layer, respectively.

### (2) Melting Point

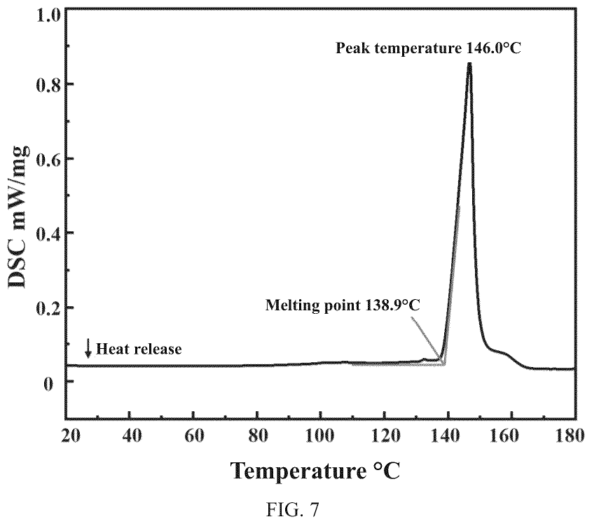

The melting point of the solder paste prepared in Example 7 was tested. The physical image of the solder paste is as shown in FIG. 7. A specific method is as follows. The solder paste was placed on an Al₃O₂ ceramic substrate for heating reflux at 150° C. for 5 minutes. As the molten solder paste and the Al₃O₂ ceramic substrate were not wet, the solder paste was shrunk into a ball under the action of surface tension, followed by cooling and solidification to obtain a solder alloy ball. Then, the solder ball was subjected to grinding and polishing to obtain a solder alloy sheet with a diameter of 12.50-12.90 mm and a thickness of 1-5 mm. Then, a DSC curve of the solder alloy was tested by a DSC 204 F1 differential scanning calorimeter. Test results are as shown in FIG. 7. The solder alloy has a peak temperature of 146.0° C. According to provisions of ICTA of Standardization Committee, the intersection point of a front baseline extension line and a maximum slope tangent line of a front edge of a peak on the DSC curve represents the melting point, and that is to say, the solder alloy has a melting point of 138.9° C.

### (3) Thermal Conductivity

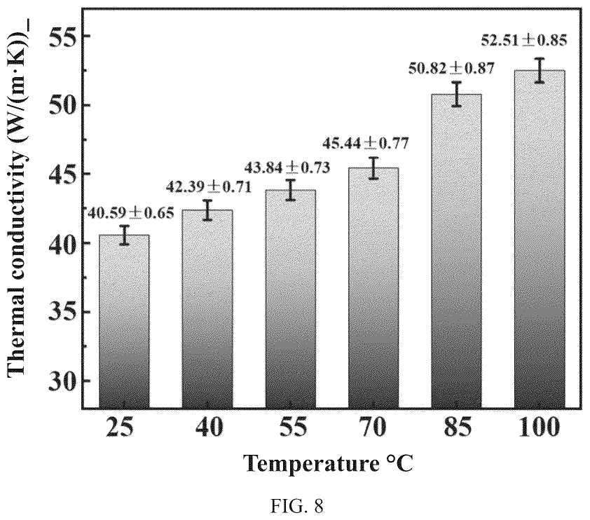

The thermal conductivity of the solder paste prepared in Example 7 was tested. A specific method is as follows. The solder paste was placed on an Al₃O₂ ceramic substrate for heating reflux at 150° C. for 5 minutes. As the molten solder paste and the Al₃O₂ ceramic substrate were not wet, the solder paste was shrunk into a ball under the action of surface tension, followed by cooling and solidification to obtain a solder alloy ball. Then, the solder ball was subjected to grinding and polishing to obtain a solder alloy sheet with a diameter of 12.50-12.90 mm and a thickness of 1-5 mm. Then, the density, thermal diffusion coefficient and specific heat capacity of the solder alloy sheet were tested by a BS210S electronic density balance, an LFA447 laser internal emission thermal conductivity analyzer and a DSC 204 F1 differential scanning calorimeter, respectively. Finally, the obtained diffusion coefficient, the specific heat capacity and the density were multiplied to obtain the thermal conductivity of the composite solder sheet. Test results are as shown in FIG.8. The solder alloy has a thermal conductivity of 40.59 W/(m·K) at 25° C., 42.39 W/(m·K) at 40° C., 43.84 W/(m·K) at 55° C., 45.44 W/(m·K) at 70° C., 50.82 W/(m·K) at 85° C. and 52.51W/(m·K) at 100° C.

The preferred embodiments of the present invention are described in detail above. However, the present invention is not limited to the specific details of the embodiments. A variety of simple variations of the technical solutions of the present invention can be made within the scope of the technical concept of the present invention, and all the simple variations fall within the protection scope of the present invention.

In addition, it should be noted that various specific technical features described in the specific embodiments can be combined in any suitable way without contradiction. In order to avoid unnecessary repetition, various possible combinations of the present invention are not described herein.

Furthermore, any combinations of different embodiments of the present invention can also be made without departing from the concept of the present invention, and the combinations shall also be deemed as the disclosed contents of the present invention.

1. A composite metal material, wherein the composite metal material is spherical, has a diameter of 20-60 μm and a three-layer core-shell structure, and comprises a Cu core, an Ag or Ni intermediate layer and an Sn shell layer.

2. The composite metal material according to claim 1, wherein a diameter of the Cu core is 15-60 μm; a thickness of the Ag or Ni intermediate layer is 0.5-2 μm,; and a thickness of the Sn shell layer is 0.5-2 μm.

3. The composite metal material according to claim 2, wherein the diameter of the Cu core is 20-50 μm.

4. The composite metal material according to claim 2, wherein the thickness of the Ag or Ni intermediate layer is 0.8-1.8 μm.

5. The composite metal material according to claim 2, wherein the thickness of the Sn shell layer is 0.8-1.8 μm.

6. The composite metal material according to claim 1, wherein a content of Cu in the Cu core is 60-98% of a total weight of the composite metal material; a content of Ag or Ni in the Ag or Ni intermediate layer is 1-20% of the total weight; and a content of Sn in the Sn shell layer is 1-20% of the total weight.

7. The composite metal material according to claim 6, wherein the content of Cu in the Cu core is 65-95% of the total weight.

8. The composite metal material according to claim 6, .wherein the content of Ag or Ni in the Ag or Ni intermediate layer is 3-18% of the total weight.

9. The composite metal material according to claim 6, .wherein the content of Sn in the Sn shell layer is 3-18% of the total weight.

10. A solder paste, comprising the composite metal material according to claim 1, an Sn—Bi series alloy powder and a flux paste, a content of the composite metal material is 10-30% of a total weight of the solder paste, and a content of the Sn—Bi series alloy powder is 10-30% of the total weight.

11. The solder paste according to claim 10, wherein the flux paste is a lead-free type rosin-based flux paste.

12. The solder paste according to claim 11, wherein the Sn—Bi series alloy powder is selected from at least one of a hypo-eutectic Sn—Bi alloy powder, an eutectic Sn-58Bi alloy powder or a hyper-eutectic Sn—Bi alloy powder with a particle size of 20-60 μm.

13. The solder paste according to claim 11, wherein the solder paste has an initial melting point of 138-140° C., a peak temperature of 140-145° C. and a thermal conductivity of 50-55 W/(m·K).

14. A device, wherein the device is obtained by welding with the solder paste according to claim 10.
